(19) United States
(12) Patent Application Publication
(10) Pub. No.: US 2023/0221146 A1
(43) Pub. Date: Jul. 13, 2023

(54) ROTATION SENSOR

(71) Applicants: JATCO Ltd, Fuji-shi, Shizuoka (JP); NISSAN MOTOR CO., LTD., Yokohama-shi, Kanagawa (JP)

(72) Inventors: Shohei IINUMA, Yamato-shi, Kanagawa (JP); Takeshi KATOU, Isehara-shi, Kanagawa (JP); Masatoshi AKANUMA, Fujisawa-shi, Kanagawa (JP); Wataru MATSUSHIMA, Ayase-shi, Kanagawa (JP)

(73) Assignees: JATCO Ltd, Fuji-shi, Shizuoka (JP); NISSAN MOTOR CO., LTD., Yokohama-shi, Kanagawa (JP)

(21) Appl. No.: 18/010,965

(22) PCT Filed: May 13, 2021
(86) PCT No.: PCT/JP2021/018291

§ 371 Date: Dec. 16, 2022

(30) Foreign Application Priority Data
Jul. 6, 2020 (JP) 2020-116299

(51) Int. Cl. G01D 5/14

(52) U.S. Cl. CPC G01D 5/145

(57) ABSTRACT

A rotation sensor includes a power supply line, a detection line, a sensor unit, and a switch, wherein a power supply voltage is applied to the sensor unit via the power supply line, and an ON voltage is applied to the switch via the power supply line, and the switch is connected to the detection line.

### TECHNICAL FIELD

The present invention relates to a rotation sensor.

### BACKGROUND ART

WO2015/076040A1 discloses a configuration for determining disconnection failure of a rotation sensor when an amount of change in rotation speed detected by the rotation sensor is equal to or greater than a predetermined value.

### SUMMARY OF INVENTION

However, the rotation sensor of WO2015/076040A1 indirectly determines the disconnection failure from the amount of change in rotation speed, and does not detect disconnection directly by a circuit configuration.

An object of the present invention is to provide a sensor having a circuit configuration capable of detecting disconnection.

According to an aspect of the present invention, a rotation sensor includes a power supply line, a detection line, a sensor unit, and a switch, wherein a power supply voltage is applied to the sensor unit via the power supply line, and an ON voltage is applied to the switch via the power supply line, and the switch is connected to the detection line.

In the above aspect, when a power supply line is disconnected, a switch is switched from an ON state to an OFF state. Therefore, the disconnection can be detected by detecting through a detection line that the switch is switched from the ON state to the OFF state. Accordingly, a sensor having a circuit configuration capable of detecting disconnection is provided.

### BRIEF DESCRIPTION OF DRAWINGS

FIG. 1 is a configuration diagram showing an example of a circuit included in a rotation sensor according to a first embodiment of the present invention.

FIG. 2 is a diagram for explaining abnormality determination based on a signal detected by the rotation sensor.

FIG. 3 is a configuration diagram showing an example of a circuit included in a rotation sensor according to a second embodiment of the present invention.

FIG. 4 is a configuration diagram showing an example of a circuit included in a rotation sensor according to a third embodiment of the present invention.

FIG. 5 is a configuration diagram showing an example of a circuit included in a rotation sensor according to a fourth embodiment of the present invention.

FIG. 6 is a configuration diagram showing an example of a circuit included in a rotation sensor according to a fifth embodiment of the present invention.

### DESCRIPTION OF EMBODIMENTS

Hereinafter, embodiments of the present invention will be described with reference to the attached drawings.

### First Embodiment

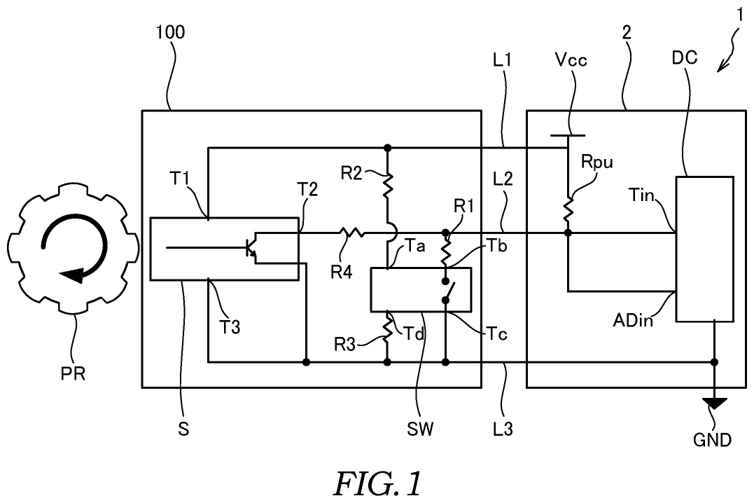

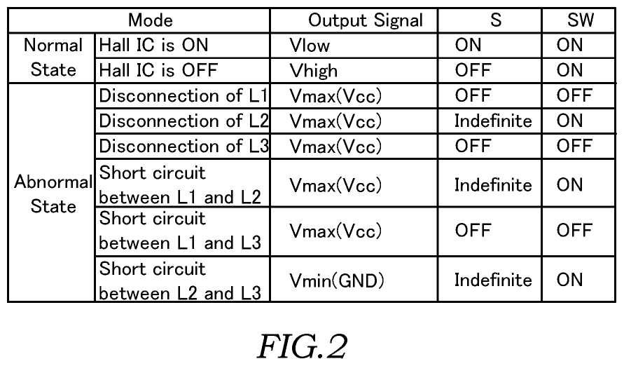

A rotation sensor 100 according to a first embodiment of the present invention will be described below with reference to FIGS. 1 and 2.

First, referring to FIG. 1, an overall configuration of the rotation sensor 100 and a rotation speed detection device 1 to which the rotation sensor 100 is applied will be described. FIG. 1 is a configuration diagram showing an example of a circuit included in the rotation sensor 100.

As shown in FIG. 1, the rotation speed detection device 1 includes the rotation sensor 100 and an electronic control unit (ECU) 2 as a control device.

The rotation speed detection device 1 inputs an output signal from the rotation sensor 100 as a pulse signal to the ECU 2, and the ECU 2 calculates a rotation speed of a pulse rotor PR as an object to be detected, based on a period of the pulse signal.

The pulse rotor PR is, for example, a member that rotates integrally with one of rotating elements of a power transmission device (a transmission, a speed reducer, or the like). However, the pulse rotor PR is not limited to these members.

The pulse rotor PR may be formed separately from a power transmission mechanism (a gear, a pulley, or the like) of the power transmission device, or may be formed integrally with the power transmission mechanism.

The rotation sensor 100 includes a sensor unit S, a switch SW, a resistor element R1 as a first resistor element, a resistor element R2 as a second resistor element, a resistor element R3 as a third resistor element, and a resistor element R4 as a fourth resistor element.

The rotation sensor 100 includes a wiring L1, a wiring L2, and a wiring L3. The rotation sensor 100 is connected to the ECU 2 by the wiring L1, the wiring L2, and the wiring L3.

The wiring L1 is connected to a power supply Vcc. The wiring L1 constitutes a positive power supply line. The wiring L1 is connected to a terminal Ti of the sensor unit S. The wiring L1 is connected to a terminal Ta of the switch SW, which will be described later, via the resistor element R2.

The wiring L2 is connected to the power supply Vcc via a resistor element Rpu as a pull-up resistor element. The wiring L2 constitutes the detection line. The wiring L2 is connected to a terminal T2 of the sensor unit S via the resistor element R4. The wiring L2 is connected to a terminal Tb of the switch SW, which will be described later, via the resistor element R1. The wiring L2 is connected to a pulse signal input unit Tin and an analog signal input unit ADin of a detection circuit DC, which will be described later.

The wiring L3 is connected to a common body earth (negative electrode) GND. The wiring L3 constitutes a negative power supply line. The wiring L3 is connected to a terminal T3 of the sensor unit S. The wiring L3 is connected to a terminal Tc of the switch SW, which will be described later. The wiring L3 is connected to the terminal Ta of the switch SW, which will be described later, via the resistor element R3.

In the present embodiment, the wiring L3 is set to a ground potential and the wiring L1 is set to a higher potential than the ground potential, but the present invention is not limited thereto, and the wiring L1 and the wiring L3 may be set so as to generate a potential difference.

In the present embodiment, a potential of the wiring L1 is set higher than a potential of the wiring L3, but the potential of the wiring L1 may also be set lower than the potential of the wiring L3. That is, it is sufficient that a potential of a voltage applied to the wiring L1 and a potential of a voltage applied to the wiring L3 are set differently.

The sensor unit S includes the terminal T1 as a positive terminal, the terminal T2 as a signal output terminal, and the terminal T3 as a negative terminal. The terminal T1 is connected to the terminal T3 inside the sensor unit S.

The sensor unit S has a function of converting rotational motion of the pulse rotor PR into a pulse signal and outputting the pulse signal. A power supply voltage is applied to the sensor unit S via the wiring L1. The sensor unit S is connected to the detection circuit DC via the resistor element R4 and the wiring L2.

For example, a Hall IC or the like using a Hall element is applied to the sensor unit S. Note that a structure of the sensor unit S is not limited thereto.

The sensor unit S operates by being supplied with power from the power supply Vcc. The sensor unit S detects a magnetic force of a magnetic body such as iron when the magnetic body approaches, and is switched to a conductive state according to the detected magnetic force. That is, the sensor unit S becomes conductive (turned on) when the magnetic body approaches, and becomes non-conductive (turned off) otherwise. Here, the sensor unit S is provided close to the pulse rotor PR. In this case, the sensor unit S is switched between the ON state and the OFF state each time the pulse rotor PR rotates and teeth of the pulse rotor PR approach. Thereby, the ECU 2 can obtain a pulse-like ON/OFF signal corresponding to the rotation of the pulse rotor PR from the sensor unit S.

The switch SW includes the terminal Ta as a control terminal, the terminal Tb as a first terminal, the terminal Tc as a second terminal, and the terminal Td as a ground terminal. An ON voltage is applied to the switch SW from the wiring L1 via the resistor element R2.

The terminal Ta is connected to the wiring L1 via the resistor element R2. A voltage for turning on the switch SW in the OFF state is supplied from the terminal Ta. The terminal Ta is connected to the terminal Td inside the switch SW.

The terminal Tb is connected to the wiring L2 via the resistor element R1.

The terminal Tc is connected to the wiring L3.

The terminal Td is connected to the wiring L3 via the resistor element R3.

When the switch SW is in the ON state, a current flows between the terminal Tb and the terminal Tc. When the switch SW is in the OFF state, the current between the terminal Tb and the terminal Tc is cut off.

The switch SW is a transistor or the like. Note that a configuration of the switch SW is not limited thereto.

When the switch SW is a bipolar transistor, the terminal Ta is a base, one of the terminals Tb and Tc is an emitter, and the other of the terminals Tb and Tc is a collector.

When the switch SW is, for example, a field emission transistor (unipolar transistor), the terminal Ta is a gate, one of the terminals Tb and Tc is a source, and the other of the terminals Tb and Tc is a drain.

An ON voltage is applied to the switch SW via the wiring L1 and the wiring L3, which are power supply lines.

The ON voltage for turning on the switch SW is reversed in positive and negative according to a polarity of the switch SW. Therefore, the power supply lines are selectively connected so that the ON voltage is applied to the switch SW.

In this way, the power supply voltage is applied to the sensor unit S via the power supply lines (wiring L1 and wiring L3), and the ON voltage is applied to the control terminal of the switch SW via the power supply lines (wiring L1 and wiring L3). Therefore, it is possible to detect disconnection of the power supply lines (wiring L1 and wiring L3). The disconnection detection of the power supply lines (wiring L1 and wiring L3) will be described later in detail with reference to FIG. 2.

The ECU 2 controls various operations of the rotation speed detection device 1. The ECU 2 is implemented by a computer including a central processing unit (CPU), a read only memory (ROM), a random access memory (RAM), and an input/output interface (I/O interface). The ECU 2 controls various operations of the rotation speed detection device 1 by reading programs stored in the ROM by the CPU.

The ECU 2 can also be implemented by a plurality of microcomputers. Note that the detection circuit DC, which will be described later, may be a virtual unit of functions executed by the ECU 2.

The ECU 2 includes the detection circuit DC and the resistor element Rpu as a pull-up resistor element.

The detection circuit DC includes the pulse signal input unit Tin and the analog signal input unit ADin. The detection circuit DC has a function of detecting a pulse signal output from the sensor unit S and input to the pulse signal input unit Tin. The detection circuit DC has a function of detecting a magnitude of the voltage of the pulse signal output from the sensor unit S and input to the analog signal input unit ADin.

The detection circuit DC detects an abnormal state of the rotation sensor 100. Specifically, the detection circuit DC can detect disconnection of the wiring L1, the wiring L2, and the wiring L3. The detection circuit DC can detect a short circuit between the wiring L1 and the wiring L2, a short circuit between the wiring L1 and the wiring L3, and a short circuit between the wiring L2 and the wiring L3.

The detection circuit DC is provided as one function within the ECU 2 of the power transmission device. That is, the detection circuit DC is provided outside the rotation sensor 100. However, the present invention is not limited to this configuration, and the detection circuit DC may be provided inside the rotation sensor 100, for example.

Hereinafter, functions of the rotation sensor 100 will be described with reference to FIG. 2. FIG. 2 is a diagram for explaining abnormality determination based on a signal detected by the rotation sensor 100.

First, a case where the rotation sensor 100 is in a normal state will be described.

The terminal Ta of the switch SW is connected to the power supply Vcc via the resistor element R2. The terminal Td of the switch SW is connected to the body earth GND via the resistor element R3. Therefore, a voltage divided by the resistor element R2 and the resistor element R3 is always applied to the terminal Ta of the switch SW. Therefore, the switch SW constituted by transistors is always in an ON state. As a result, the wiring L2, which is a detection line, is connected to the body earth GND via the resistor element R1.

When the sensor unit S is in an ON state, since the terminal T2 is connected to body earth GND, a voltage Vlow, which is a voltage divided by the resistor element Rpu and parallel-connected resistor elements R4 and R1, is input to the pulse signal input unit Tin and the analog signal input unit ADin.

In this case, the detection circuit DC detects the magnitude of the voltage input to the analog signal input unit ADin. The voltage Vlow input to the analog signal input unit ADin is slightly higher than a voltage Vmin of the body earth GND. Thereby, the detection circuit DC detects that a signal when the sensor unit S is in the ON state is normal.

On the other hand, when the sensor unit S is in the OFF state, no current flows through the resistor element R4. However, since a current flows through the resistor element Rpu and the resistor element R1, a voltage Vhigh, which is a voltage divided by the resistor element Rpu and the resistor element R1, is applied to the pulse signal input unit Tin and the analog signal input unit ADin.

In this case, the detection circuit DC detects the magnitude of the voltage input to the analog signal input unit ADin. The voltage Vhigh input to the analog signal input unit ADin is slightly lower than a voltage Vmax of the power supply Vcc. Thereby, the detection circuit DC detects that a signal when the sensor unit S is in the OFF state is normal.

Next, a case where an abnormality occurs in the rotation sensor 100 will be described.

When at least one of the wiring L1 and the wiring L3, which are power supply lines, is disconnected, or when the wiring L1 and the wiring L3 are short-circuited, the switch SW is always in the OFF state. Therefore, it becomes equivalent to the case without the resistor element R1.

In this case, since no power is supplied to the sensor unit S, the sensor unit S is not turned on, and is turned off or indefinite.

When the sensor unit S is in the OFF state, no current flows through the resistor element R4. Therefore, the voltage Vmax of the power supply Vcc is input to the pulse signal input unit Tin and the analog signal input unit ADin.

Similarly, when the sensor unit S is indefinite, since no power is supplied to the sensor unit S, substantially no current flows through the resistor element R4. Therefore, the voltage Vmax of the power supply Vcc is input to the pulse signal input unit Tin and the analog signal input unit ADin.

When the wiring L2, which is a detection line, is disconnected, the voltage Vmax of the power supply Vcc is applied to the pulse signal input unit Tin through the resistor element Rpu. Therefore, the voltage Vmax is input to the pulse signal input unit Tin and the analog signal input unit ADin.

When the wiring L1, which is a power supply line, and the wiring L2, which is a detection line, are short-circuited, the voltage Vmax of the power supply Vcc is directly applied to the pulse signal input unit Tin. Therefore, the voltage Vmax is input to the pulse signal input unit Tin and the analog signal input unit ADin.

When the wiring L2, which is a detection line, and the wiring L3, which is a power supply line, are short-circuited, the pulse signal input unit Tin is directly connected to the body earth GND. Therefore, the voltage Vmin is input to the pulse signal input unit Tin and the analog signal input unit ADin.

As described above, when the wiring L1, the wiring L2, and the wiring L3 are in a normal state, the voltage input to the pulse signal input unit Tin and the analog signal input unit ADin is the voltage Vhigh or the voltage Vlow. However, when at least one of the wiring L1, the wiring L2, and the wiring L3 is in an abnormal state, the voltage input to the pulse signal input unit Tin and the analog signal input unit ADin is the voltage Vmax or the voltage Vmin.

Here, the detection circuit DC recognizes both the voltage Vmax and the voltage Vhigh input to the pulse signal input unit Tin as an “H (High)” signal. The detection circuit DC recognizes both the voltage Vmin and the voltage Vlow input to the pulse signal input unit Tin as an “L (Low)” signal.

In this case, in the detection circuit DC, based on the magnitude of the voltage input to the analog signal input unit ADin, the presence or absence of abnormality can be determined by detecting whether the voltage of the signal recognized as the “H” signal is the voltage Vmax or the voltage Vhigh, or the voltage of the signal recognized as the “L” signal is the voltage Vmin or the voltage Vlow. Therefore, the detection circuit DC can detect whether the rotation sensor 100 is in a normal state or in an abnormal state.

According to the first embodiment described above, the following effects are exerted.

In the rotation sensor 100, for example, when the wiring L1 or the wiring L3, which is a power supply line, is disconnected, the switch SW is switched from the ON state to the OFF state. Therefore, the disconnection of the wiring L1 or the wiring L3 can be detected by detecting that the switch SW is switched from the ON state to the OFF state via the wiring L2, which is a detection line. Therefore, a rotation sensor 100 having a circuit configuration that can detect disconnection is provided.

In the present embodiment, the wirings L1, L2, and L3 necessary for the operation of the rotation sensor 100 are used to detect that the rotation sensor 100 is in an abnormal state. Therefore, an abnormality of the rotation sensor 100 can be detected without increasing the number of wirings.

### Second Embodiment

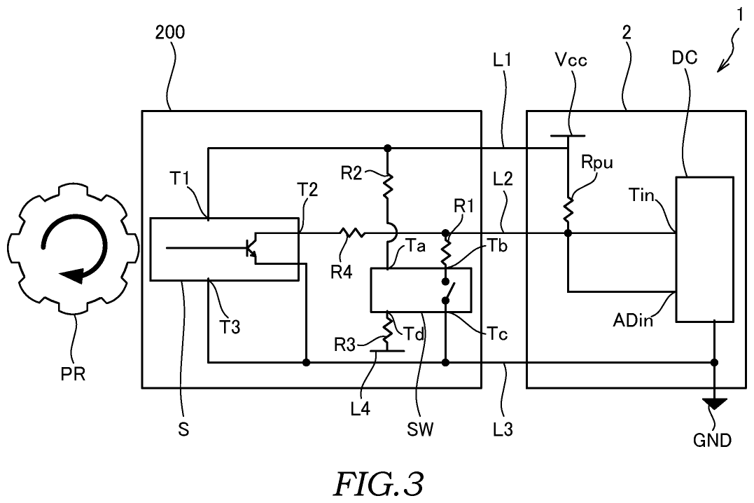

A rotation sensor 200 according to a second embodiment of the present invention will be described below with reference to FIG. 3. FIG. 3 is a configuration diagram showing an example of a circuit included in the rotation sensor 200. In each embodiment described below, points different from the first embodiment will be mainly described, and the same reference numerals will be given to the components having the same functions, and description thereof will be omitted.

The rotation sensor 200 differs from the rotation sensor 100 according to the first embodiment in that the resistor element R3 is connected to another wiring L4 instead of the wiring L3.

The wiring L4 constitutes a power supply line. As with the wiring L3, the wiring L4 is a wiring having a potential difference from the wiring L1.

According to the second embodiment, it is possible to detect disconnection of at least the wiring L1 functioning as a power supply line.

Note that in FIG. 3, the potential of the wiring L1 and the polarity of the switch SW are set so that the wiring L1 can apply the ON voltage of the switch SW.

### Third Embodiment

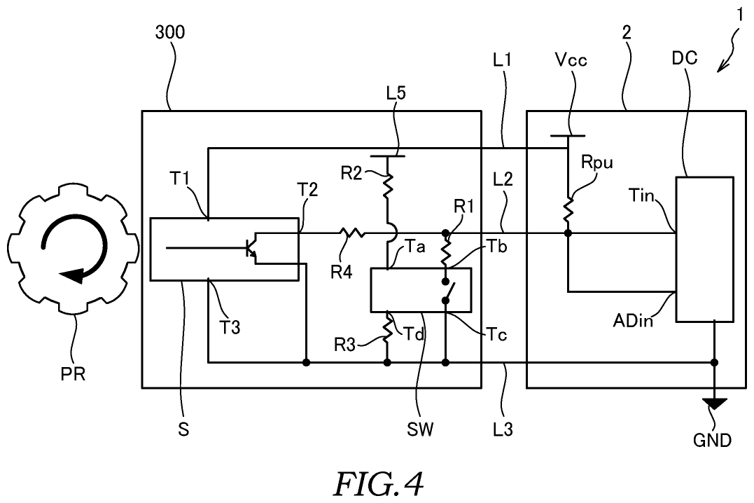

A rotation sensor 300 according to a second embodiment of the present invention will be described below with reference to FIG. 4. FIG. 4 is a configuration diagram showing an example of a circuit included in the rotation sensor 300.

The rotation sensor 300 differs from the rotation sensor 100 according to the first embodiment in that the resistor element R2 is connected to another wiring L5 instead of the wiring L1.

The wiring L5 constitutes a power supply line. As with the wiring L1, the wiring L5 is a wiring having a potential difference from the wiring L3.

According to the third embodiment, it is possible to detect disconnection of at least the wiring L3 functioning as a power supply line.

Note that in FIG. 4, the potential of the wiring L2 and the polarity of the switch SW are set so that the wiring L2 can apply the ON voltage of the switch SW.

### Fourth Embodiment

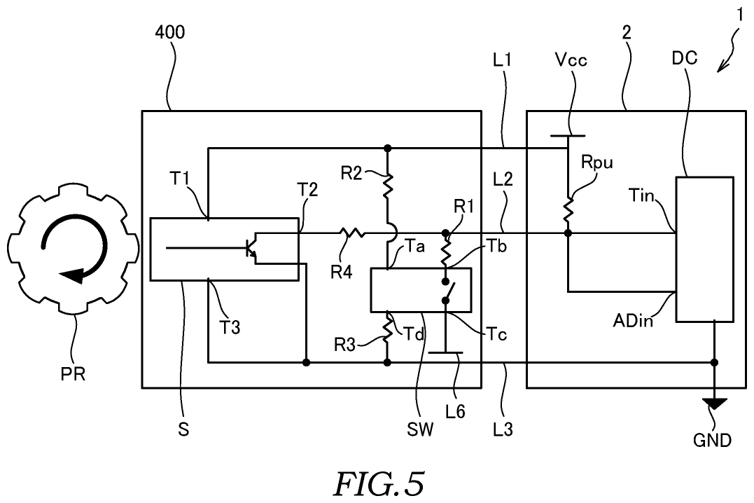

A rotation sensor 400 according to a fourth embodiment of the present invention will be described below with reference to FIG. 5. FIG. 5 is a configuration diagram showing an example of a circuit included in the rotation sensor 400.

The rotation sensor 400 differs from the first embodiment in that the terminal Tc of the switch SW is connected to another wiring L6 instead of the wiring L3.

The wiring L6 constitutes a power supply line. The wiring L6 is a wiring having a potential difference from the wiring L2.

### Fifth Embodiment

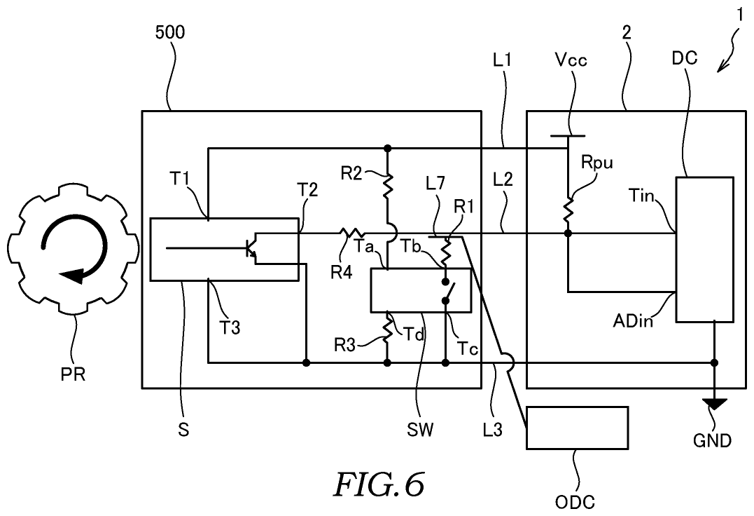

A rotation sensor 500 according to a fifth embodiment of the present invention will be described below with reference to FIG. 6. FIG. 6 is a configuration diagram showing an example of a circuit included in the rotation sensor 500.

The rotation sensor 500 differs from the first embodiment in that the terminal Tb of the switch SW is connected to another wiring L7 instead of the wiring L2.

The wiring L7 constitutes a detection line. The wiring L7 is connected to another detection circuit ODC.

The configuration and effects of the present embodiment described above will be collectively described.

(1) In the rotation sensor 100, 200, 300, 400, 500 including the wiring L1 (or L3), which is a power supply line, the wiring L2 (or L7), which is a detection line, the sensor unit S, and the switch SW, the sensor unit S is applied with a power supply voltage via the wiring L1 (or L3), and the switch SW is applied with the ON voltage via the wiring L1 (or L3), and is connected to the wiring L2 (or L7).

In the above aspect, when the wiring L1 (or L3), which is a power supply line, is disconnected, the switch SW is switched from the ON state to the OFF state. Therefore, the disconnection of the wiring L1 (or L3) can be detected by detecting that the switch SW is switched from the ON state to the OFF state via the wiring L2 (or L7), which is a detection line. Therefore, the rotation sensor 100, 200, 300, 400, 500 having a circuit configuration that can detect disconnection is provided.

Note that the switch SW naturally has a predetermined resistance value even when it is in the ON state. Therefore, it can be said that the present circuit configuration simulates the presence or absence of a resistor element by switching the switch SW between the ON state and the OFF state.

(2) The wiring L2 is connected to the terminal T2, which is a signal output terminal of the sensor unit S.

According to this configuration, the detection line and detection circuit for disconnection detection and the detection line and detection circuit for sensing may be provided separately, but by providing the wiring L2 with both functions of detecting the output of the sensor unit S and detecting disconnection, it is possible to prevent an increase in the number of detection lines and detection circuits.

(3) The wiring L2 (or L7) is connected to the switch SW via the resistor element R1 as the first resistor element.

In order to improve detection accuracy, it is preferable that a resistance value of the resistor element connected to the wiring L2 (or L7) as a detection line is high. Therefore, according to this configuration, the detection accuracy can be improved by providing the resistor element R1 separately from the switch SW.

(4) An ON voltage is applied to the switch SW from the wiring L1 via the resistor element R2 as the second resistor element.

According to this configuration, a decrease in durability of the switch SW can be prevented by lowering the voltage applied to the switch SW by the resistor element R2.

Although the embodiments of the present invention have been described above, the above-mentioned embodiments are merely a part of application examples of the present invention, and do not mean that the technical scope of the present invention is limited to the specific configurations of the above-mentioned embodiments.

For example, a circuit configuration in which the concepts of FIGS. 1 and 3 to 6 are combined with each other is possible. Specifically, it is possible to combine FIGS. 3 and 4, or to combine FIGS. 4 to 6, and the present invention is not limited to these combinations exemplified here.

Note that since the wirings and the switch naturally have a predetermined resistance value, it is possible to omit the resistor elements R1, R2, R3, and R4 in FIGS. 1 and 3 to 6, but from the viewpoint of improving circuit accuracy, it is preferable to provide the resistor elements R1, R2, R3, and R4.

In the above embodiments, the configuration for detecting an abnormality of the rotation sensors 100, 200, 300, 400, and 500 is described, but a configuration for detecting an abnormality such as a displacement sensor whose object to be detected is not a rotating body may also be used.

The wirings L1 to L7 used in the above embodiments may be wires, or may be circuit patterns provided on an electronic board. In other words, the wirings L1 to L7 may be of any kind as long as they can be electrically connected to components.

The present application claims priority under Japanese Patent Application No. 2020-116299 filed to the Japan Patent Office on Jul. 6, 2020, and an entire content of this application is incorporated herein by reference.

1. A rotation sensor, comprising:
a power supply line;
a detection line;
a sensor unit; and
a switch, wherein
a power supply voltage is applied to the sensor unit via the power supply line, and
an ON voltage is applied to the switch via the power supply line, and the switch is connected to the detection line.

2. The rotation sensor according to claim 1, wherein the detection line is connected to a signal output terminal of the sensor unit.

3. The rotation sensor according to claim 1, wherein the detection line is connected to the switch via a first resistor element.

4. The rotation sensor according to claim 1, wherein
an ON voltage is applied to the switch from the power supply line via a second resistor element.
